(19) United States
(12) Patent Application Publication
(10) Pub. No.: US 2012/0215328 A1
(43) Pub. Date: Aug. 23, 2012

(54) PHYSICAL ACTIVITY MONITORING AND RECORDING SYSTEM AND DEVICE

(76) Inventor: Richard Schmelzer, Boulder, CO (US)

(21) Appl. No.: 13/344,478

(22) Filed: Jan. 5, 2012

Related U.S. Application Data
(60) Provisional application No. 61/445,753, filed on Feb. 23, 2011.

(51) Int. Cl. G06F 19/00

(52) U.S. Cl. 700/91

(57) ABSTRACT

This disclosure describes systems, methods, and apparatus for monitoring motion or other activity and using the successful completion of a goal to unlock or lock functionality or features of an electronic device or applications running on a computing system. In particular, media devices and the features within can be disabled unless a proof of completion of a physical activity goal or other challenge is provided to the media device or a server controlling features of the media device. Alternatively, features can be unlocked on the media device when proof of completion of a physical activity goal or other challenge is provided.

### PRIORITY AND CROSS REFERENCE TO RELATED APPLICATIONS

This application claims the benefit of Provisional U.S. Patent Application No. 61/445,753 filed on Feb. 23, 2011. The details of Application No. 61/445,753 are incorporated by reference into the present application in their entirety and for all proper purposes.

### FIELD OF THE DISCLOSURE

Aspects of the this disclosure relate generally to recording and monitoring physical activity, and in particular to managing electronic device access and features based on real-world activities.

### BACKGROUND

One third of America's children are overweight or obese. Parents try to encourage exercise, but as computer-based technologies and social media and networking pervade ever more aspects of childrens' lives, exercise often takes second chair to these less healthy forms of entertainment. Some have tried to prevent overuse of television and gaming by creating parental locks on televisions. For instance, U.S. Pat. No. 5,231,310 discloses a parental television lock, and U.S. Pat. No. 5,060,079 discloses a parental television lock where children can unlock the television for periods of time selected by a parent via use of a programmed card that tracks the child's television usage and remaining time allotment. Others have realized that exercise and television need not be separate and competing interests. U.S. Pat. No. 6,376,936 discloses a wireless on and off switch for a television where the switch is controlled by a threshold of peddling speed on a stationary bike.

### SUMMARY OF THE DISCLOSURE

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Some embodiments of the disclosure may be characterized as methods including storing, accessing, converting, storing, receiving, determining, and fulfilling. The storing includes storing user activity data in a memory, where the user activity data describes a user activity. The accessing includes accessing the user activity data in the memory via a processor. The converting includes converting the user activity data to a value via the processor. The storing includes storing the value in the memory. The receiving includes receiving a request to enable a user device, user device feature, user device application, or feature of a user device application. The determining includes determining if the request can be met with the value in the memory, via the processor. The fulfilling includes fulfilling the request if there is sufficient value.

Other embodiments of the disclosure may also be characterized a system for locking and unlocking user devices. The system can include a memory and a processor. The memory can be for storing user activity data that describes a user activity. The processor can be configured to convert the user activity data to a value and store the value in the memory. The processor can also be configured to receive a request to enable a user device, user device feature, user device application, or feature of a user device application. It can further be configured to determine if the request can be met with the value, and also to fulfill the request if there is sufficient value.

Other embodiments of the disclosure can be characterized as tangible computer readable media embodying a method of locking and unlocking user devices, features, applications, and features of applications. The method can include storing user activity data in a memory, where the user activity data describes a user activity. The method can also include accessing the user activity data in the memory via a processor. The method can further include converting the user activity data to a value via the processor. The method additionally can include storing the value in the memory. Furthermore, the method can include receiving a request to enable a user device, user device feature, user device application, or feature of a user device application. The method can also include determining if the request can be met with the value in the memory, via the processor. Finally, the method can include fulfilling the request if there is sufficient value.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1 illustrates a method of controlling access to electronic devices, features, and applications based on user activity.

FIG. 2 illustrates a system configured to manage locking and unlocking of devices, features, applications, and features of applications running on a user device, based on user activity.

FIG. 3 illustrates a system configured to carry out another embodiment of enabling or unlocking devices, features, applications, and features of applications on a user device.

FIG. 4 illustrates another method of controlling access to electronic devices, features, applications, and features of those applications based on user activity.

FIG. 5 illustrates a diagrammatic representation of one embodiment of a machine in the exemplary form of a computer system within which a set of instructions can execute for causing a device to perform or execute any one or more of the aspects and/or methodologies of the present disclosure.

### DETAILED DESCRIPTION

This disclosure discloses systems, methods, and apparatus aimed at encouraging exercise and other activities by locking and unlocking (disabling and enabling) functionality in a computing device, such as a smartphone, laptop computer, or a television, to name just a few, based on completion of real-world exercise (e.g., running) or other real-world activities (e.g., completing a homework assignment). Other aspects of this disclosure can be characterized as systems, methods, and apparatus to lock and unlock (disable and enable) functionality in applications running on a computing device based on completion of real-world activities.

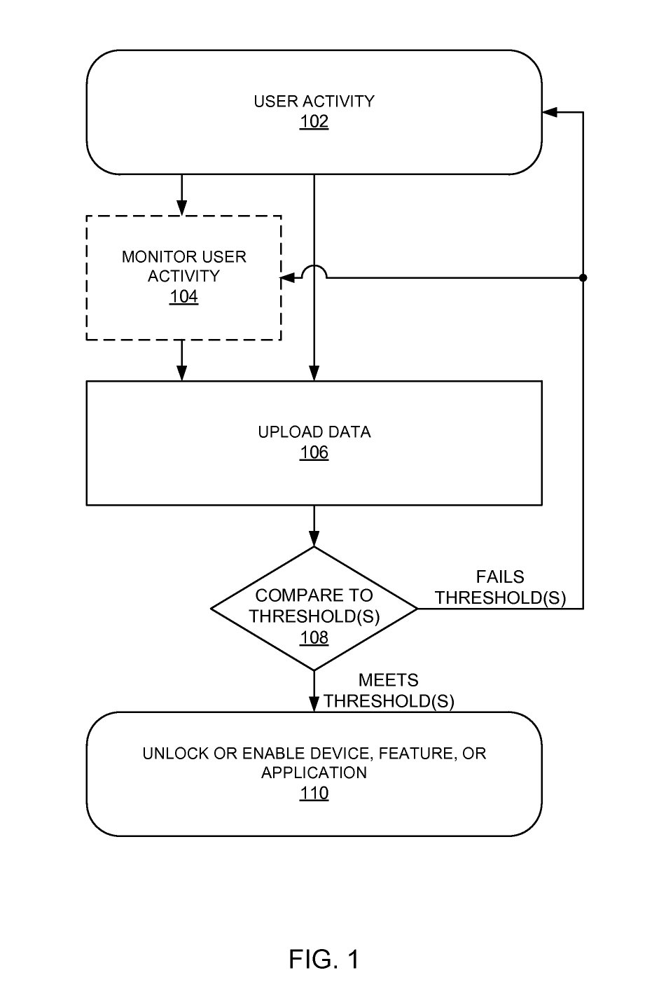

FIG. 1 illustrates a method of controlling access to electronic devices, features, and applications based on user activity. In the method 100, a user engages in an activity (e.g., exercise or working on a math assignment for school) in the user activity operation 102. This activity can optionally be monitored via monitor user activity operation 104. Based on the user's monitoring of his/her activity or via a monitoring device that performs the optional monitoring operation 104, data describing the user activity (user activity data) or a level of completion of the user activity can be uploaded to one or more remote servers in an upload data operation 106. The one or more remote servers can compare the data to one or more thresholds in a compare to threshold(s) decision 108. If the data fails to meet the threshold, then the method 100 can return to the user activity operation 102 or optional monitor user activity operation 104. If the threshold is met, then the one or more remote servers can unlock or enable functionality or a feature of a computing device or an application running on a computing device in an unlock or enable functionality or feature operation 110. In this way, the locking and unlocking of a computing device can be used as a goal to incentivize user activity.

The user activity operation 102 can involve a variety of user activities. A short and non-limiting list of examples includes, exercising, walking, running, playing a sport, lifting weights, moving between destinations, working on a school assignment, performing errands or chores, reading a book, completing tasks at work, earning grades at school or in a class, completing a course or continuing legal education, attending seminars, reaching a friend's house, attending a music lesson or band practice, or attending a tutoring session. Clearly, the types of user activities envisioned stretch far beyond mere exercise.

The optional monitor user activity operation 104 can be performed where the user does not enter his/her own data describing the user activity. A monitoring device such as a pedometer, GPS locator or module within a mobile computing device (e.g., cell phone or smartphone), triangulation module using cellular tower signal strength and phase detection within a mobile computing device, accelerometer, gyroscope, to name a few, can be used to monitor the user activity. In many cases, the monitor user activity operation 104 includes monitoring physical activity or exercise. For instance, a pedometer can be used to measure a number of steps taken by a user over a period of time.

Monitoring can be continuous or periodic. For instance, when monitoring user steps using a pedometer, monitoring may be continuous. However, where monitoring user position using GPS, the GPS coordinates may only be sampled every few seconds or every few milliseconds.

Monitoring can include counting a value related to the user activity (e.g., counting a number of steps or a number of destinations reached or a number of math problems on a homework assignment completed), measuring a quality of the user activity (e.g., measuring an average running speed or a percentage of math problems on a homework assignment correctly answered), or watching for a completion of a predefined goal (e.g., watching for a user to walk/run ten miles or for a user to complete a series of chores or errands or for a user to complete all homework assignments for a night). Monitoring may involve monitoring user vital signs such as heart rate, blood pressure, or VO₂ max, to name a few non-limiting examples.

While many of the examples so far discussed have related to user motion or exercise, some user activity 102 may relate to completion of tasks such as homework, reading books, or earning grades in school, to name just a few examples. In such cases, the monitoring device may be a computing device such as a student's computer or an electronic reader (e.g., AMAZON KINDLE), or a remote server monitoring a school's online grade postings. For instance, the monitor user activity operation 104 may use a remote server to monitor a student's completion of homework problems or assignments that are submitted on the Internet or are completed on a web-based portal. The remote server may monitor not only completion of assignments but the quality of the completed work, for instance a number of correctly answered math problems. Alternatively, the user may manually indicate, via a web portal, the completion of a homework assignment or a number of correctly answered questions.

The monitoring may even relate to a home tutoring system unaffiliated with a school. In the case of reading books, a user may enter the completion of a book into a web portal interface or an electronic reader may automatically note when the user has flipped to the last page of a digital book or article. A user can enter grades into a web portal or a remote server can remotely monitor online grade postings. As seen, there are a variety of non-exercise-related user activities that can be monitored and a variety of ways to monitor those activities.

User activity data can include data provided to a computing device by a user. For instance, a user can manually enter user activity data into a computing device such as a laptop or smartphone. User activity data can also be autonomously measured and then provided to a processor of a computing device, for instance where a user device both monitors user activity and is the device that is locked or unlocked based on that activity. User activity data can also be provided to a remote server after being manually uploaded to a computing device or after being autonomously monitored and uploaded by a monitoring device.

Once the user has data describing the user activity or the monitoring device has acquired data from the optional monitor user activity operation 104, the method 100 can include uploading the data 106. Data can be uploaded to one or more remote servers having a memory where the data can be cached or stored. Where a monitoring device has accumulated the data, the monitoring device can automatically upload the data or a user can manually upload the data. Automatic uploading can include wired or wireless upload of data from the monitoring device to the one or more remote servers. For instance, a motion sensor (e.g., pedometer or smartphone) can wirelessly connect to the Internet, either through a wireless router or a cellular data network, and upload the data. In another embodiment, the monitoring device can be passed within close proximity (e.g., 0-10 centimeters) to a near field communications (NFC) receiver, thus downloading the data via a combination of physical user action and an automatic software download protocol. Alternatively, a monitoring device can be connected to a computing device that has a connection to the Internet or a cellular data network, and the data can be uploaded via connection to the computing device (e.g., USB, FIREWIRE, THUNDERBOLT, HDMI).

In another embodiment, a user can read the data from the monitoring device and manually enter the data into a computing device that uploads the data to the one or more remote servers. For instance, a pedometer can read, “1052 steps,” the user can type this number into a number entry user interface of a laptop computer or smartphone, and the laptop or smartphone can upload the typed data to the one or more remote servers.

One challenge of the upload data operation 106 is the threat of user dishonesty. In other words, how does the system ensure that the uploaded data is accurate. One solution is automated data upload as discussed above. However, where the user manually uploads the data other, encryption of the data or corroboration by a third party can be employed. In one embodiment, a monitoring device may provide a user with an encrypted version of the data. The user can upload the encrypted data and the remote servers can decrypt the data. For instance, a pedometer can provide a multi-digit code for the user to upload, where the code corresponds to a number of steps taken but cannot be interpreted by the user.

Another check on data accuracy is to require a third-party to approve any user uploads of data. For instance, a child may upload a number of yoga exercises performed in a day, but a parent may be required to confirm this number before any devices, features, or software can be unlocked. In an embodiment, the third-party approval may be performed via the same web portal that the user uses to input the data. Alternatively, an e-mail or other notification can be sent to the third-party after the user uploads the data, and the notification can include a link or selection boxes allowing the third-party to confirm or contest the user's data. Some exemplary third parties include a parent, guardian, teacher, and boss.

Instead of a third-party, a computer may approve the user's data upload. For example, where the user enters grades earned during a prior semester, a computer may extract the user's grades from an online source of grades and compare them to the user's input to ensure user honesty. In another embodiment, the user may not be given an option of uploading activity data until a computer has determined that the user met a threshold of user activity. For instance, a computer may monitor an employee's tasks during the day, and after the user has completed a set number of tasks, the computer may enable an interface or web portal where the user can input the number and quality of tasks completed. Prior to enablement of the interface or web portal, the employee would be unable to enter activity data.

Once the data has been uploaded, it can be compared to one or more thresholds in the compare to threshold(s) decision 108. The compare decision 108 determines whether sufficient activity has been accomplished to enable or unlock a device, feature, or application. For instance, the compare to threshold(s) decision 108 may compare a number of correctly-answered math homework problems to a percentage goal set by a teacher or parent. As another example, the compare decision 108 may compare a number of chores completed to a threshold number set by a parent for a given Saturday morning. In other words, the compare to threshold(s) decision 108 determines whether the user activity meets a predefined goal.

The compare to threshold(s) decision 108 is not limited to comparisons to a single threshold. For instance, where the activity data is converted to various levels or quantities of functionality or features, the data may be compared to multiple thresholds. Moving 1000 steps in a day may unlock a television for one hour of viewing, while 2000 steps may unlock the television for two hours. To determine how much television viewing time is unlocked, the activity data can be compared to two different thresholds—one at 1000 steps and one at 2000 steps. When a user runs one mile, the Internet may be unlocked, but when they run three miles, games and e-mail may also be unlocked.

In some cases, unlocking or enabling can be based on multiple types of thresholds being met. A user device may remain unlocked until a certain amount of exercise has been achieved as well as homework for the night. Or, a user device may be unlocked when a certain amount of exercise is complete, but some applications (e.g., games) remain locked until the child's homework has also been completed.

If the comparison to threshold(s) decision 108 determines that sufficient activity has not been engaged in or completed, or that the quality of activity is not sufficient (e.g., not enough correct math problems were answered), then the method 100 can return to the user activity 102 or the optional monitoring operation 104. If the activity or quality of the activity is sufficient, then the method 100 can unlock or enable a device, features, or an application in an unlock or enable operation 110.

Devices can include computers (e.g., laptops, desktops, ultrabooks, netbooks, tablet computers, to name a few), smartphones, cellular phones, televisions, MP3 players, radios, game consoles, DVD and BLUE RAY players, streaming media devices, and others. The device may be a form of lock on a door or a container (e.g., lock to a toy drawer or a game room). The unlock or enable operation 110 can unlock or enable any of these devices, features of the devices, or applications running on the devices. For instance, if a child runs at least two miles in a day or completes all of his/her homework for a night, then a computer may be unlocked so that it can power up or come out of a standby or locked mode.

In other embodiments, these devices may only be partially locked and unlocked. This may include unlocking or enabling applications on a device. For instance, a computer's productivity software (e.g., WORD or EXCEL) may remain unlocked at all times so that a student can always work on homework or other productivity tasks, while games, the Internet, and e-mail clients may be locked. When sufficient activity has been completed to meet the threshold(s) of the compare to threshold(s) decision 108, then one or more of these applications can be unlocked or enabled. In another embodiment, a 911 or other emergency calling feature of a phone may remain enabled even when some or all other features or functionality of the phone are locked or disabled.

In one embodiment, a feature of an application running on a user device can be unlocked or enabled. In other words, while the device and an application running on the device may remain unlocked, features of the application may be locked until the user accomplishes certain activities. For instance, where the application is a game, new powers, abilities, characters, levels, challenges, weapons, tools, characteristics, titles, etc. may be unlocked or enabled. The user activity to be completed may be related or unrelated to the functionality or features that are unlocked or enabled within the application. For instance, when a user survives four piano lessons in a week, the user's avatar in a favorite game may gain increased strength or speed. In some embodiments, online game money can be awarded for successful completion of certain user activities or qualities of activity.

Features of applications that can be locked and unlocked are not limited to the gaming context. For example, special features of a movie may be unlocked or additional episodes of a TV season may become available. The radio of a car that is wirelessly connected to the Internet may be enabled upon the user achieving sufficient activity.

Devices, features, and application can be unlocked for fixed or indefinite period of time. For instance, devices, applications, and features can be unlocked or enabled for minutes, hours, days, weeks, months, other periods of time, or indefinitely. For instance, if a student receives at least a 3.0 grade point average for a term, then a television may become unlocked for the next term or may be unlocked indefinitely (e.g., where a parent locked television access as a punishment and can now remove the punishment indefinitely). In an embodiment, the amount of time can be based on the quantity or quality of the activity. For instance, a user who completes one of five errands may unlock a gaming console for one hour while completing three of the five errands may unlock the gaming console for four hours.

In an embodiment, locking and unlocking of devices, features, and applications can be governed by a lock/unlock application installed on the user device or via a web-based application. As one example, a parent having a child who loves to use PHOTOSHOP, may install a locking/unlocking application on the child's computer and use corresponding software on the parent's computer or on a web application to lock advanced functionality within PHOTOSHOP unless the child performs certain activities or qualities of activity. As another example, a boss having an employee who is inefficient due to excessive web surfing, may install a lock/unlock application on the employee's computer and use the application to disable all web browsers until the employee completes certain tasks each day. The lock/unlock application can be familiar with a variety of third-party applications and thus have the ability to lock or disable features of a variety of different third-party applications often found on user devices.

Unlocking may involve modification of a quality of service. For instance, a user's activity may lead to unlocking of different Internet speeds. Where a user completes a minimal amount of exercise, network speed may be limited, whereas completion of a larger amount of exercise may lead to faster network speeds. Perhaps completion of a homework assignment allows a user to watch television, but completion of the homework assignment with a certain quality of work (e.g., number of answers correctly provided or a certain grade achieved) enables high definition resolution or the ability to watch a program without advertisements.

The devices may only be locked for certain users. For instance, at the login screen for WINDOWS multiple user profiles can be defined, and profiles for parents may not be locked, while a child's profile may remain locked until the unlock or enable operation 110 unlocks the profile. Parental access may be governed by a password to prevent the child from accessing the parent's profile.

In one embodiment, the method 100 can be performed locally—without any uploading or calculations on remote servers. For instance, the monitoring device can perform the monitor user activity operation 104, compare the activity to thresholds in the comparison decision 108, and unlock or enable the device being monitored or a feature or application of the device being monitored (unlock or enable operation 110). As a more specific example, a child may carry a smartphone while exercising, and when sufficient exercise has been completed, the phone may unlock itself so that the child can make phone calls or surf the Internet or play games.

Alternatively, the monitoring device can provide data regarding the monitored user activity to another local device, where the local device functionality or features of the local device are unlocked. This may occur, for instance where the monitoring device is a pedometer, which passes activity data to the user's smartphone or laptop, and where the smartphone or laptop is unlocked, or features are enabled, based on comparisons to threshold(s) either on the pedometer or the smartphone or laptop. In other words, the activity monitoring (operation 104), determination (decision 108) as to whether sufficient activity has been performed, and unlocking 110 can be carried out locally without the assistance of remote servers or even a connection to the Internet or another network. However, it is also possible that the monitoring device can pass the data to the other local device via the Internet or another network without the data being stored or cached on a remote server and without the remote server performing the comparison or enabling functionality or features of the local device or applications running on the local device.

Select user devices or all user devices can be locked and unlocked. Certain applications or all applications associated with some or all of a user's devices can be locked or disabled. Profiles can be created, where each profile corresponds to a user and identifies devices and/or applications on those devices that are locked or disabled. Another user such as a parent or boss can switch between various profiles for a user such as a child or employee depending on the day of the week, a time of year, or other circumstances. For instance, a parent may switch from a first child's profile to a second profile for the same child when the child misbehaves such that the second profile makes it harder for the child to unlock devices, applications, and features.

The method 100 is not limited to the applications and users described in exemplary embodiments above. Rather, the method 100 can be used in a variety of applications where one person is trying to incentivize another. Parents, teachers, supervisors, and employers, are three examples of persons who may wish to implement the method 100. Health insurers and doctors are others that may find the method 100 useful for creating incentives for clients and patients, respectively, to perform certain tasks (e.g., increased exercise).

In some embodiments, the compare to threshold(s) decision 108 can be replaced with a step of converting user activity data to incentives (e.g., online game cash or unlocked time on a game console or television). For instance, rather than comparing use activity data to a plurality of thresholds, the user activity data can be converted to a reward based on the quantity or quality of the user activity.

In an embodiment, rather than comparing the user activity to a predefined goal, user activity data can be converted to an exchangeable value, such as points, credits, or an online currency, to name a few. The conversion rate between user activity data and the exchangeable value (e.g., points) can be selected or defined by a third party such as a parent, teacher, or supervisor. When a user unlocks a device, feature, application, or feature of an application, a certain number or percentage of the exchangeable value assigned to the user can be deducted. Users can also have profiles that track the number of points or other exchangeable value that they have remaining. Points, credits, or other exchangeable value can be deducted on a per usage basis or on the basis of time. For instance, one credit may be deducted every fifteen minutes of television viewing time.

A user may have to log into their profile in order to use credits, points, or other exchangeable value. For instance, when watching television, a user may have to log into their profile before the television unlocks and credits from their profile begin to be used. In situations where more than one user has access to a device, logging into a user profile may be one way to track who is using the device and thus whose profile should have points deducted from it. However, this may also allow two users to use a device simultaneously while only logging in as a single user, thus giving users the ability to ‘cheat’ the system. In such cases, facial recognition (e.g., MICROSOFT KINECT) can be used to monitor who is using a device and automatically deduct points without requiring a login. If multiple users are accessing a device and one of the users runs out of points or credits, the device may lock up until that user stops using the device (e.g., by leaving the room).

In one embodiment, when a user requests to use or unlock a device, feature, application, or feature of an application, a third party (e.g., a parent) may receive a notification prompting them to enter an amount of time that the user can use the device, feature, application, or feature of an application, before it locks again.

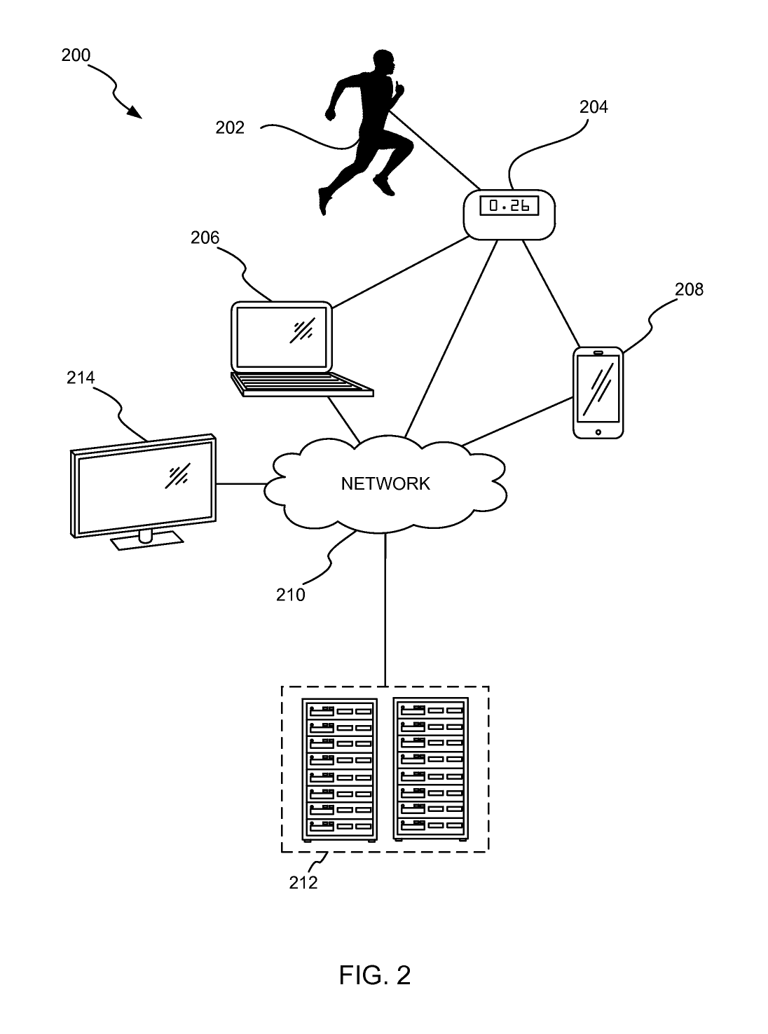

FIG. 2 illustrates a system 200 configured to manage locking and unlocking of devices, features, applications, and features of applications based on user activity. Although not part of the system 200, a user 202 can engage in an activity such as exercise or a task such as a homework assignment. A monitoring device 204 can monitor the activity in terms of quantity and quality. The monitoring device 204 can provide data describing the activity to one or more user devices belonging to the user 202, such as a laptop 206 or a smartphone 208 (other computing devices can also be implemented).

The monitoring device 204 and the user devices 206, 208 can communicate with a network 210 (e.g., the Internet or a cellular data network). In one embodiment, the monitoring device 204 communicates directly to the network 210 (e.g., via WiFi connection or a cellular data network connection), and in another embodiment, it connects to the network 210 via one or both of the user devices 206, 208. Also in communication with the network are another user device 214 such as a television, and one or more remote servers 212.

The monitoring device 204 can communicate with the one or more servers 212 via the network 210. The monitoring device 204 can also communicate with the user devices 2106, 208, 214 via the network 210. The user devices 206 and 208 can communicate with the one or more servers 212 and the user device 214 via the network 210. The user device 214 can communicate with the one or more servers 212 via the network 210.

Although not illustrated, the user devices 206, 208, and 214 can be in communication via a local area network (LAN) such as a household or business Ethernet. So, where activity data is uploaded to the user device 206, and the user device 206 determines that the user activity is of sufficient quantity or quality, the user device 206 may unlock the user device 208, or functions or features of the user device 208, via the LAN rather than via the network 210.

In an embodiment, the user 202 engages in an activity that is monitored by the monitoring device 204. The monitoring device 204 then passes activity data (data describing the activity) to one or both of the user devices 206, 208 via a wired or wireless connection or via the network 210. The user devices 206, 208 can compare the activity data to one or more thresholds and determine whether the user 202 engaged in sufficient activity or a sufficient quality of activity. If not, then the user devices 206, 208 remain locked, or features of those devices 206, 208 remain disabled, or applications or features of applications running on those devices 206, 208 remain disabled. If the activity meets the thresholds, then the user devices 206, 208 can be enabled, or features of those devices 206, 208 can be enabled, or applications or features of applications running on those devices 206, 208 can be enabled.

The threshold(s) can be selected by a third party (e.g., a parent, supervisor, or teacher). Comparison of activity data to thresholds can be performed by the user devices 206, 208 or by the monitoring device 204. If performed by the monitoring device 204, then an indication that a sufficient quantity or quality of activity has been performed can be passed to the user devices 206, 208, or the network 210, rather than activity data.

The user 202 can also read activity data from the monitoring device 204 and input the activity data into the user devices 206, 208. The activity data may be encrypted to prevent user 202 manipulation of the activity data. In this embodiment, the one or more servers 212 can be omitted.

In an embodiment, after the monitoring device 204 or the user devices 206, 208 have determined that sufficient user 202 activity has occurred, an indication can be passed to the user device 214 via the network 210 enabling the user device 214, features, or an application.

In an embodiment, comparing the activity data to one or more thresholds (or determining if sufficient user 202 activity has occurred) can be performed by the one or more remote servers 212. In such an embodiment, the monitoring device 204 can pass the activity data to the one or more remote servers 212 via the network 210 or via the user devices 206, 208. The one or more remote servers 212 can compare the activity data to one or more thresholds and determine whether sufficient activity or a sufficient quality of activity has occurred to enable a device, features of a device, an application of the device, or features of an application running on a device. If so, then the one or more remote servers 212 can pass an indication to the user devices 206, 208, 214 enabling or unlocking a device, feature, or application.

The monitoring device 204 can be a pedometer, GPS, device for triangulating position based on cellular tower signals, gyroscope, or accelerometer, to name a few non-limiting examples. The monitoring device 204 can have a display for displaying activity data to the user 202, such as mileage traveled, average speed, or steps taken, to name a few. The monitoring device 204 may encrypt the activity data such that the display only shows encrypted activity data. It may also be configured to wirelessly communicate with the user devices 206, 208 or the network 210 (e.g., via WIFI, a cellular data connection, SMS, WIMAX, ZIGBEE, infrared, near field communications), or to connect to the user devices 206, 208 via a wired connection (e.g., USB). The monitoring device 204 can automatically upload activity data via these wired or wireless connections or can upload the activity data when such a connection exists and the user 202 activates such an upload.

The monitoring device 204 can be attached to the user 202, for instance via a belt or waist connection or a band holding the monitoring device 204 to the user's 202 wrist, arm, or ankle. The monitoring device 204 can also be built into, or be a component of, other devices such as a wristwatch, heart-rate monitor, GPS locator, smartphone, or music player. In one embodiment, the monitoring device 204 can be part of exercise equipment, such as a stationary bike, treadmill, spinning machine, or elliptical. The monitoring device 204 can be fixed to sporting equipment such as a bike or kayak. The monitoring device 204 may also be affixed to an article of clothing such as a built-in pocket, shoelace, shoe, headband, or hat.

In another embodiment, the monitoring device 204 can be worn while the user 202 plays a video game (e.g., console or computer game). The monitoring device 204 (e.g., a pedometer) may wirelessly (or via a wired connection) communicate activity data to a game console, television, or computer. Such communications can made be via the network 210 or via direct communication with the device upon which the game is running. The game can use the activity data during game play to provide an additional source of control over the game. For instance, in a first person shooter, the monitoring device 204 may record steps taken by the user 202 and convert these steps into motion of the player in the game.

A third party (e.g. parent, teacher, supervisor) can select which user devices, features, applications, and features of applications are to be locked. Such selection can be made via a web portal or via profiles of users (e.g., children) that are stored on one or more remote servers. In some case, a third party can select devices, features, applications, or features of applications that are to lock if a user has failed to complete a goal or task by a certain time. For instance, if a homework assignment is not finished by 7 pm, then the Internet connection to the student's computer may be disabled.

In an embodiment, a user can upload activity data that can be converted to a value (e.g., credits, points, etc.). The value can be added to any existing value associated with the user or the user's profile. The user can make a request to enable a device, feature, application, or feature of an application and the request can be received by one or more remote servers. The one or more remote servers can compare the request to the value associated with the user or the user's profile to determine if the request can be met with the value associated with the user or the user's profile. Each request may require a different value to be met. If the user has sufficient value, then the request can be met. If not, then the user request is denied. If the request is fulfilled (e.g., enable a smartphone), the one or more servers can track the users usage while the request is fulfilled and if the value falls below a threshold required to continue fulfilling the request, then the one or more servers may cease fulfilling the request (e.g., disable a smartphone).

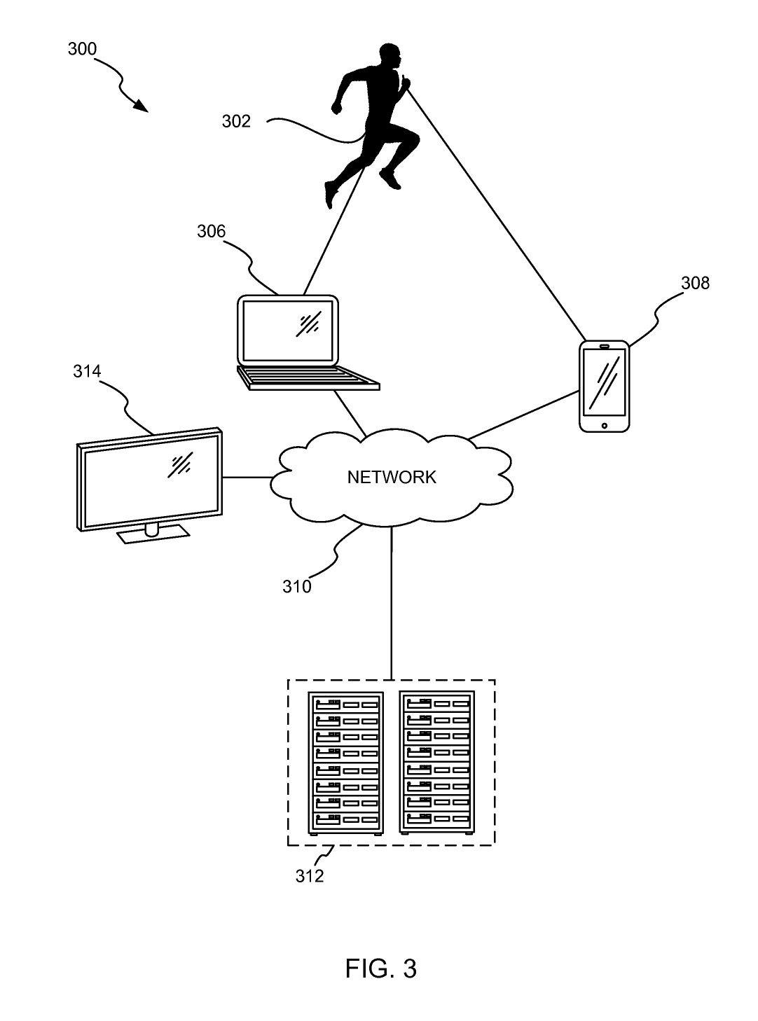

FIG. 3 illustrates a system 300 configured to carry out another embodiment of enabling or unlocking functionality or features of one of the devices or applications running on one of the devices. A user 302 engages in an activity such as exercise or a task. User devices 306, 308 can monitor the activity in terms of quantity and quality. The user devices 306, 308 can then determine whether sufficient quantity or quality or activity has been performed before unlocking or enabling their functionality, a feature of the user devices 306, 308, an application running on the user devices 306, 308, or a feature of an application running on the user devices 306, 308.

Alternatively, after determining that the user 302 has performed sufficient quantity or quality of activity, one of the user devices 306, 308 can provide an indication of the same to the user device 314 via the network 310 thus enabling or unlocking the user device 314, functionality of the user device 314, an application running on the user device 314, or a feature of an application running on the user device 314.

In another alternative, the determination as to whether the user 302 performed sufficient quantity or quality of activity can be performed by the one or more remote servers 312. If the user 302 has performed sufficiently, then the one or more remote servers 312 can unlock or enable one or more of the devices 306, 308, 314, features of those devices 306, 308, 314, applications on those devices 306, 308, 314, or features of applications on those devices 306, 308, 314.

In some embodiments, the user 302 may be involved in an activity that is not monitored by a device. For instance, the user 302 may be completing a homework assignment, receiving grades, completing continuing legal education, attending a seminar, or doing chores. The user 302 may indicate to either of the user devices 306, 308 that one of these activities has been completed and may also indicate a quality associated with completion of the activity (e.g., via text entry in a web portal). The user device 306, 308 or the one or more remote servers 312 can determine whether the activity is sufficient to unlock devices, features, or applications. In an embodiment, a third party may be required to corroborate what the user indicates regarding completion of activities.

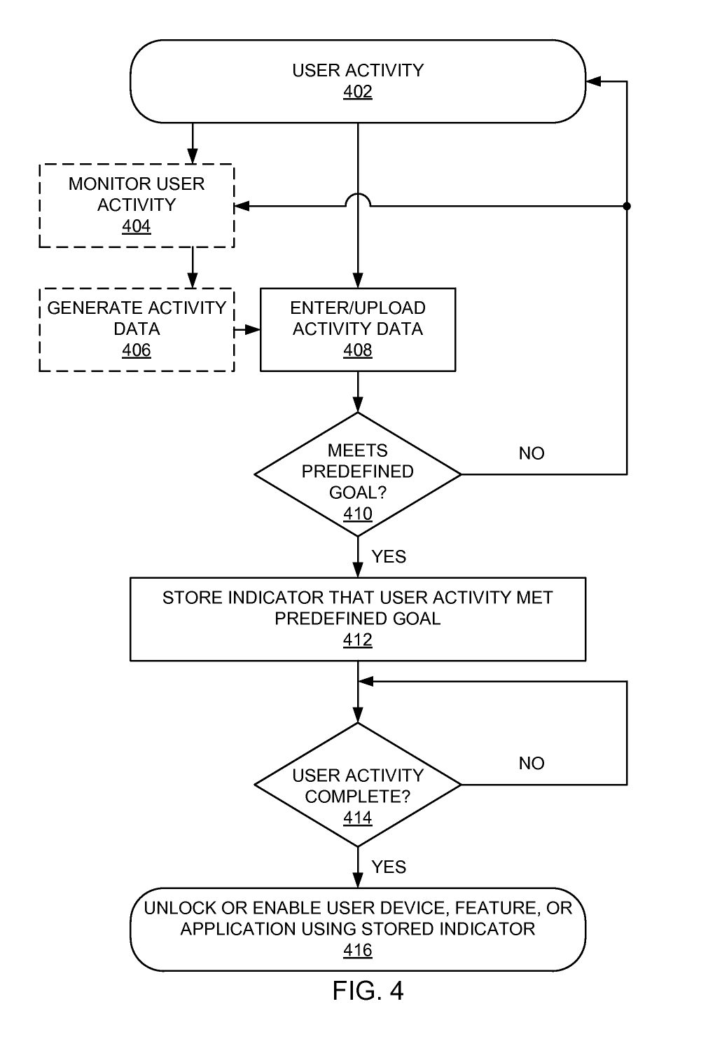

FIG. 4 illustrates another method of controlling access to electronic devices, features, applications, and features of applications based on user activity. The method 400 includes monitoring a user activity, generating activity data describing the user activity, determining whether the user activity meets a predefined goal, storing an indicator that the user activity meets the predefined goal, and unlocking a user device function using the stored indicator at that time or a later time (e.g., after the user activity has finished).

In particular, a user activity 402 occurs and can be monitored by optional monitor user activity operation 404. The monitoring can generate activity data in optional generate activity data operation 406. The activity data can be entered or uploaded in enter/upload activity data operation 408. This operation 408 can be carried out by the user (e.g., entering mileage from a GPS or steps from a pedometer into a web-based user interface on a smartphone or laptop computer) or can be automated (e.g., wireless or wired upload of activity data from a monitoring device). The activity data can be uploaded to one or more remote servers or to a local user device.

A meets predefined goal decision 410 then decides whether the user engaged in a sufficient quantity or quality of activity. If not, then the method 100 returns to either the user activity 402 or the optional monitor operation 404 (depending on whether the optional monitor operation 404 is in effect). This determination can be made by one or more remote servers, by a user device other than a monitoring device, or by the monitoring device.

If the goal has been met, then an indicator of the same is stored in a store indicator operation 412. The indicator that the user activity met the predefined goal can be stored in a local memory or cache or on a remote memory or cache, for instance in a remote server. The importance of the store operation 412 is that the device, feature, application, or feature of a device need not be unlocked immediately. Rather, the unlocking can occur at a later time, a time selected by the user. For instance, a child can perform exercise on Monday, but not cash in the exercise for a period of unlocked Internet time until Thursday.

The method 400 then optionally determines whether the user activity 402 has been completed in user activity complete decision 414. If not, then the method 400 loops back to the decision 414 until the user activity 402 has finished. In cases where the user device, feature, application, or feature of an application is to be used while the user activity is still ongoing, the user activity complete decision 414 is not used. In such cases, an unlock operation 416 can operate before or after the user activity 402 finishes.

If the user activity complete decision 414 is in operation, then once the user activity 402 has completed, the method 400 unlocks or enables a user device, user device feature, user application, or feature of a user device application using the stored indicator in an unlock or enable operation 416. Unlocking or enabling a device feature can include enabling a feature of an application running on the device such as a bonus level in a video game.

The present disclosure presents a greater incentive for user activity than is possible in the art, since the incentive is not limited to use during the user activity—it can be saved and cashed in at a later time, thus giving the incentive greater value to a user. Moreover, the user activity and the incentive are both user defined; a parent can select an exercise for a child and decide which of the child's devices are to be unlocked by certain amounts of exercise and for how long they will remain unlocked.

This disclosure often refers to enabling or unlocking devices or their functionality. It is to be understood that such references include enabling a device (e.g., allowing a smartphone to power up), enabling functionality on the device (e.g., 1080 p rather than 720 p display resolution on a television; enabling a network connection of a laptop computer; allowing a faster Internet connection speed), enabling an application configured to run on the device (e.g., allowing MADDEN NFL 2012 to open and run; enabling an e-mail client; unblocking the FACEBOOK webpage), or enabling a feature of an application configured to run on the device (e.g., enabling an e-mail client to send e-mails; unlocking special abilities of a video game character).

Although the user devices 206, 306, 208, 308, 214, 314 are illustrated as a laptop, smartphone, and television, respectively, these are not meant to be limiting representations. Rather they merely illustrate some examples of various user devices. Others are also envisioned. For instance, the user device 206 can be a cellular phone, smartphone, desktop computer, ultrabook, tablet computer, television, set-top box (or cable box), streaming media player (e.g., ROKU, or APPLETV), or game console (e.g., XBOX or PLAYSTATION 3), to name a few non-limiting examples.

The one or more servers 212, 312 can include one or more sets of computing systems working in parallel to perform various computing tasks, and can be arranged in a single computing rack or distributed amongst various racks in one or more locations.

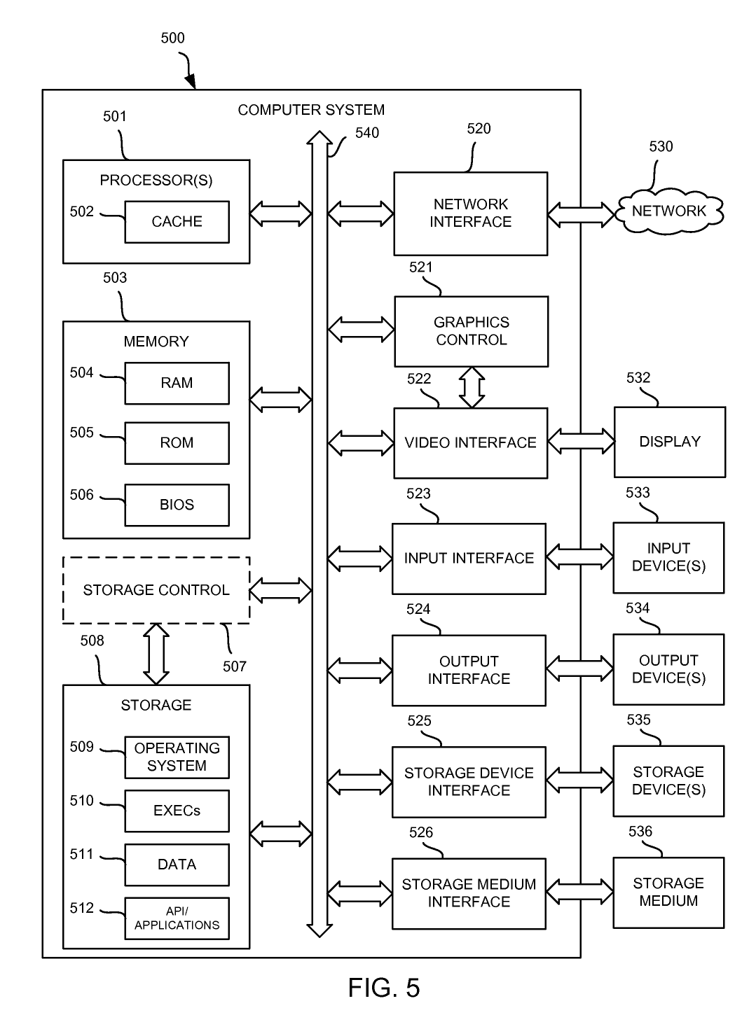

The systems and methods described herein can be implemented in a machine such as a computer system in addition to the specific physical devices described herein. FIG. 5 shows a diagrammatic representation of one embodiment of a machine in the exemplary form of a computer system 500 within which a set of instructions can execute for causing a device to perform or execute any one or more of the aspects and/or methodologies of the present disclosure. The components in FIG. 5 are examples only and do not limit the scope of use or functionality of any hardware, software, embedded logic component, or a combination of two or more such components implementing particular embodiments.

Computer system 500 may include a processor 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 501 (or central processing unit(s) (CPU(s))) optionally contains a cache memory unit 502 for temporary local storage of instructions, data, or computer addresses. Processor(s) 501 are configured to assist in execution of computer readable instructions. Computer system 500 may provide functionality as a result of the processor(s) 501 executing software embodied in one or more tangible computer-readable storage media, such as memory 503, storage 508, storage devices 535, and/or storage medium 536. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., a static RAM “SRAM”, a dynamic RAM “DRAM, etc.), a read-only component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, EXECs 510 (executables), data 511, APV applications 512 (application programs), and the like. Often, although not always, storage 508 is a secondary storage medium (such as a hard disk) that is slower than primary storage (e.g., memory 503). Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide nonvolatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above. In an embodiment, the input interface is configured to receive user activity data from a network (e.g., the Internet or a cellular data network).

In particular embodiments, when computer system 500 is connected to network 530, computer system 500 may communicate with other devices, specifically mobile devices and enterprise systems, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 530, may employ a wired and/or a wireless mode of communication. In general, any network topology may be used.

Information and data can be displayed through a display 532. Examples of a display 532 include, but are not limited to, a liquid crystal display (LCD), an organic liquid crystal display (OLED), a cathode ray tube (CRT), a plasma display, and any combinations thereof. The display 532 can interface to the processor(s) 501, memory 503, and fixed storage 508, as well as other devices, such as input device(s) 533 (user input device(s)), via the bus 540. The display 532 is linked to the bus 540 via a video interface 522, and transport of data between the display 532 and the bus 540 can be controlled via the graphics control 521.

The user input device 533 can include, but is not limited to the following: a keyboard, touchscreen, computing device, mouse, and microphone.

In addition to a display 532, computer system 500 may include one or more other peripheral output devices 534 including, but not limited to, an audio speaker, a printer, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

In conclusion, the present invention provides, among other things, a method, system, and apparatuses that lock or disable a user device and only unlock the device, or a device function, upon a user completing a quantity and/or quality of an activity. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A method comprising:
storing user activity data in a memory, where the user activity data describes a user activity;
accessing the user activity data in the memory via a processor;
converting the user activity data to a value via the processor;
storing the value in the memory;
receiving a request to enable a user device, user device feature, user device application, or feature of a user device application;
determining if the request can be met with the value in the memory, via the processor; and
fulfilling the request if there is sufficient value.

2. The method of claim 1, further comprising associating the value with a first user, the first user being the one making the request.

3. The method of claim 2, further comprising disabling a user device, user device feature, user device application, or feature of a user device application if the first user has insufficient value to meet the request.

4. The method of claim 2, further comprising decreasing the value as the request is fulfilled.

5. The method of claim 4, further comprising disabling the user device, user device feature, user device application, or feature of a user device application when insufficient value remains.

6. The method of claim 1, wherein the user activity data describes motion.

7. The method of claim 1, further comprising receiving encrypted user activity data and decrypting the encrypted user activity data.

8. The method of claim 1, wherein the fulfilling of the request occurs after the user activity has finished.

9. The method of claim 1, wherein the processor and the memory are of one or more remote servers.

10. The method of claim 1, wherein the processor is of the user device.

11. The method of claim 1, wherein a second user determines a conversion ratio defining what quantity and quality of user activity data converts to different values.

12. The method of claim 1, wherein fulfilling the request includes transmitting instructions to the user device.

13. A system comprising:
a memory for storing user activity data that describes a user activity; and
a processor configured to:
convert the user activity data to a value;
store the value in the memory;
receive a request to enable a user device, user device feature, user device application, or feature of a user device application;
determine if the request can be met with the value; and
fulfill the request if there is sufficient value.

14. The system of claim 13, further comprising associating the value with a first user, the first user being the one making the request.

15. The system of claim 14, further comprising disabling a user device, user device feature, user device application, or feature of a user device application if the first user has insufficient value to meet the request.

16. The system of claim 14, further comprising decreasing the value as the request is fulfilled.

17. The system of claim 13, further comprising an input interface configured to receive the user activity data from a motion sensor.

18. The system of claim 13, further comprising an input interface configured to receive the user activity data from a network.

19. The system of claim 13, wherein the value can be selected from the group consisting of: credits, points, or electronic currency.

20. A tangible computer readable media embodying a method of locking and unlocking user devices, features, applications, and features of applications, the method comprising:
storing user activity data in a memory, where the user activity data describes a user activity;
accessing the user activity data in the memory via a processor;
converting the user activity data to a value via the processor;
storing the value in the memory;
receiving a request to enable a user device, user device feature, user device application, or feature of a user device application;
determining if the request can be met with the value in the memory, via the processor; and
fulfilling the request if there is sufficient value.
